(19) United States
(12) Patent Application Publication
(10) Pub. No.: US 2005/0226161 A1
(43) Pub. Date: Oct. 13, 2005

(54) System for monitoring the upstream and downstream cable modem channel

(76) Inventor: Richard C. Jaworski, Alpharetta, GA (US)

Correspondence Address: RICHARD C. JAWORSKI, 350 SPYGLASS BLUFF, ALPHARETTA, GA, 30022, US

(21) Appl. No.: 10/708,994

(22) Filed: Apr. 6, 2004

(51) Int. Cl. H04L 1/00

(52) U.S. Cl. 370/241

(57) ABSTRACT

A system for monitoring the upstream and downstream channels of a cable modem system, using a cable modem or cable modem status monitoring transponder. With additional software, a central monitoring computer and a field cable modem or field cable modem status monitoring transponder, this invention provides a means of monitoring the upstream and downstream path's performance. By utilizing hardware already existing in cable modems or cable modem status monitoring transponders, this invention monitors the upstream and downstream continuously for lost packets, and the downstream channel continuously for Modulation Error Ratio (MER), Bit Error Rate (BER) and carrier level. The system notifies cable system personnel when problems exist in either the upstream or downstream channels so that technicians may be dispatched to the field quickly to effect repair.

### CROSS REFERENCE TO RELATED APPLICATIONS

Application Ser. No. 09/704,888, System and Method for Testing the Upstream Channel of a Cable Network, inventor Richard C. Jaworski et al. filed Nov. 1, 2000 describes an approach to testing the upstream channel. Application No. 10/083,749, System of testing the upstream cable modem channel, inventor Richard C Jaworski, filed Feb. 25, 2002.

### BACKGROUND OF INVENTION

With the advent of the Internet and the desire for high speed Internet access at homes and businesses, cable television networks that were originally designed to distribute television signals are now being used to provide high speed Internet, and telephony over the high speed Internet service. The service to provide high speed Internet and data access over cable networks is commonly known as Cable Modem service. The service to provide telephony over the high speed Internet service infrastructure is commonly known as Voice Over Internet Protocol (VoIP). Cable Modem service has become the leading method of providing high-speed data access to consumers in the United States. VoIP service over the Cable Modem service has become very popular with consumers and is growing rapidly due to its low cost compared to conventional embodiments.

FIG. 1 shows a typical cable modem implementation in a cable network. A device known as the Cable Modem Termination System (CMTS) 10 is the device at the central office or headend that communicates with all of the cable modems in the network that reside at subscriber homes and businesses. The CMTS 10 acts as an interface between the Internet backbone 12 and the Hybrid Fiber Coax (HFC) network 18. The Internet backbone 12 is well known in the art and is comprised of routers, coaxial and fiber optic communications lines. The CMTS 10 connects to the HFC network 18 through a combiner/splitter 14 where the signal from the CMTS 10 is combined with the television signals 16 to be carried on the HFC network to subscribers homes 22. The bi-directional HFC network 18 is comprised of fiber optic and coaxial lines and their associated equipment. Bi-directional HFC networks 18 are well known in the art and allow signals to be carried in the direction towards the subscriber or downstream, and the direction from the subscriber or upstream. In alternate embodiments of HFC Networks 18, coaxial only, or fiber only networks may be used.

A plurality of subscriber's homes 22 is connected to the HFC network by means of coaxial cable 20. Alternatively businesses may be connected to the network instead of homes via coaxial cable 20. FIG. 2 shows the connection from the HFC network 18 to the cable modem 28 and television 26. At the subscriber's home 22 the cable modem 28 and television 26 are connected to the coaxial cable 20 through a splitter 24. This arrangement of a coaxial cable 20 and splitter 24 is well known in the art. It is also well known to the art that this coaxial cable 20 connection with the HFC network 18 is bi-directional and can carry signals both in the downstream and upstream directions. The cable modem 28 is connected to the computer 30 to provide it with network access. The VoIP Terminal 29 is connected to the cable modem to provide the VoIP Terminal 29 with network access allowing it to connect to VoIP Gateway 13 over the network. The subscriber's telephone 31 is connected to the VoIP Terminal providing the telephone with telephone service. All subscriber homes 22 have this basic connection to the television 26, the cable modem 28 and the computer 30 and the various embodiments of this basic design include multiple televisions 26 and/or multiple cable modems 28 and computers 30 and/or the VoIP terminal 29 and telephone 31.

The CMTS 10 communicates with the cable modem 28 on the downstream using a digital channel on the HFC Network 18. This channel is shared by many cable modems in the area. Data for individual cable modems is time multiplexed with other cable modems on single channel. Each cable modem on the network monitors the data on the channel and picks off the data appropriate for that modem. Any problems on the downstream digital channel of HFC Network 18 can cause errors in the data received by the modem resulting in packets to be lost. Packets lost on the downstream can impair performance of the channel causing a slow down or complete lack of connection during browsing of the Internet. In the case of a VoIP telephone call, packets lost on the downstream can result in call break up or a dropped call.

The upstream channel on the HFC Network 18 from the subscriber's cable modem 28 to the CMTS 10 is also shared by all of the modems in the area. Each cable modem 28 must take turns transmitting its data to the CMTS 10 based on a schedule that has been transmitted on the downstream from the CMTS 10. Unlike the forward channel signal, upstream data packets are not multiplexed with signals from other cable modems and the entire packet payload comprises data from a single cable modem.

Upstream channels on cable networks are susceptible to noise and interference known as ingress due to the inherent funneling effect of the HFC upstream. The effect of noise and ingress on the upstream in HFC networks 18 is well known to the art. This noise and interference in the upstream can have negative affects on the quality of data transmitted on the upstream. These negative affects manifest themselves on data traffic as lost packets and can cause a slow down or complete disruption of service. On VoIP traffic the result can be call break up or dropped calls.

In order to compete with the quality of other services such as Digital Subscriber Line (DSL) and conventional telephony over twisted pair a high degree of system performance and reliability is required. Problems on the HFC network 18, especially on the upstream, need to be located and corrected quickly before subscribers notice degradation in performance. Subscribers that have VoIP service will notice problems even sooner due to the high susceptibility of VoIP to lost packets. Cable systems need to know immediately when a problem exists in the network and dispatch a technician as soon as possible to repair the problem, hopefully before the problem is noticed by subscribers. To accomplish this, a method of monitoring the network performance is needed, especially on the upstream channel.

Since it is well known to the art that the upstream channel is highly effected by the quality of the return path of the HFC network 18, systems have been developed to monitor the performance of the return path and notify cable system personnel of any ingress or noise detected, so a repair can be made quickly. Unfortunately current systems have been shown to miss various forms and frequencies of ingress for various reasons. A more effective method for determining if a problem exists is to exercise the network with a lost packet test as described in application Ser. No. 09/704,888, System and Method for Testing the Upstream Channel or in application Ser. No. 10/083,749, System of testing the upstream cable modem channel. These methods have been commonly used in portable test instruments, and are not suited for long term system monitoring.

FIG. 3 shows a system currently in use that monitors the status of components in HFC network 18. Components monitored include Fiber Node 40, Power Supply 42 and Amplifier 44. Other components or locations may be monitored as well. Monitoring is accomplished by Cable Modem Status Monitoring Transponder 46. Cable modem status monitoring transponder 46 is based around cable modem technology, such as DOCSIS, EuroDOCSIS or other cable modem standards. Cable modem status monitoring transponder 46 uses existing hardware designed for consumer cable modems including integrated circuits from Broadcom Corporation and other manufacturers. By utilizing existing cable modem infrastructure and low cost consumer components, a status monitoring system consisting of cable modem status monitoring transponders 46 as well as a Status Monitoring System Computer 48 with appropriate software connected anywhere on the Internet, a system for monitoring some parameters of the HFC Network 18 can be achieved. Cable modem status monitoring transponders 46 monitor critical parameters of the equipment they are located in or near, and report back any problems identified to the Status monitoring system computer 48 which is located in a monitoring center. Personnel at the monitoring center note problems reported by the system and can dispatch a technician to the location of the transponder and repair the problem.

While the status monitoring system described in FIG. 3 provides an important function monitoring system components it does not measure the performance of the upstream or downstream digital channels. There is an additional need to monitor the upstream and downstream performance of the network in order to detect problems quickly and have them resolved.

### SUMMARY OF INVENTION

It is the objective of this invention to provide a system that leverages on current cable modem status monitoring technology or individual cable modems to provide a means of monitoring the performance of the upstream and downstream cable modem paths continuously and in real time. It is the further objective of this invention to provide a means of reporting the performance of the upstream and downstream cable modem paths to a computer located somewhere on the Internet or private network. It is the further objective of this invention to report to a computer located on the Internet or private network any problems detected on the upstream and/or downstream cable modem paths. Measurement parameters covered by this invention:
Lost packet testing using conventional pinging that does not isolate problems to either the upstream or downstream. Conventional pinging tests are well known to the art and testers that perform such a test are widely available.
Lost packet testing attributed to just the upstream path as covered in application Ser. No. 09/704,888, System and Method for Testing the Upstream Channel of a Cable Network or application Ser. No. 10/083,749, System of testing the upstream cable modem channel.
Downstream Modulation Error Ratio (MER), Signal to Noise Ratio (SNR), downstream Bit Error Rate (BER) calculated using Forward Error Correction (FEC), and downstream receive level. Downstream MER, BER and receive level measurements are well known to the art and testers that perform such tests are widely available.

While all of the tests mentioned above should be considered prior art, they have only been implemented as a field tester. This invention provides for these tests to be implemented within a fixed cable modem based status-monitoring transponder or stand alone cable modem as a system that continuously monitors the performance of the upstream and downstream paths in the field or headend based on the above measurement parameters. Implementation of the above tests in a cable modem status monitoring transponder or stand alone cable modem provides a unique low cost and highly effective means of monitoring the upstream and downstream performance without the need for additional hardware normally associated with these tests. The above tests can be implemented within the software of the cable modem within the transponder or stand alone cable modem for a highly efficient low cost system. The invention further provides for reporting the performance and/or problems to a computer on the Internet or private network.

### BRIEF DESCRIPTION OF DRAWINGS

FIG. 1 is a block diagram of a conventional Hybrid Fiber Coax (HFC) cable network.

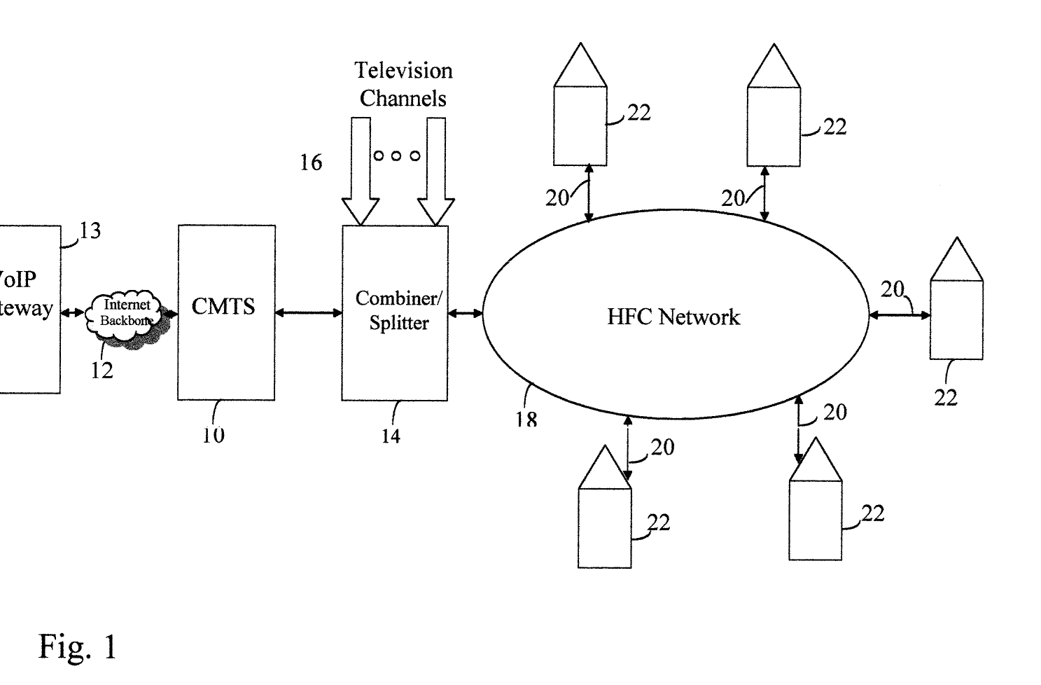

FIG. 2 is a block diagram of the connections of a cable subscriber's television, cable modem, computer, VoIP Terminal and telephone to the HFC network.

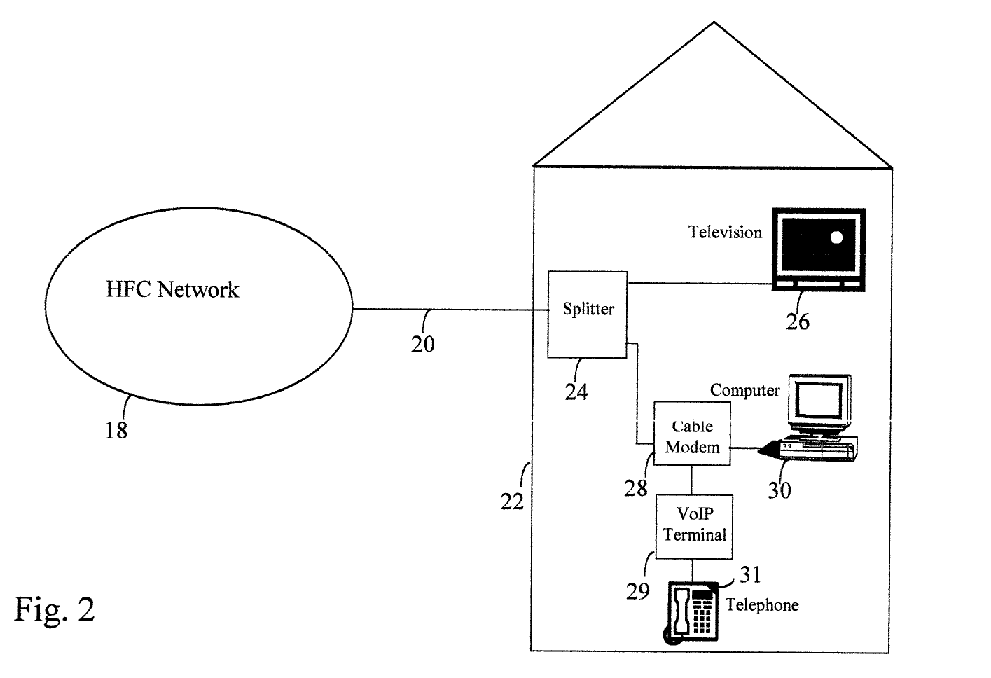

FIG. 3 is a block diagram of typical locations where a cable modem status monitoring transponder that includes upstream and downstream tests according to the present invention could be located to monitor the cable network.

FIG. 4 is a block diagram of a portion of the system according to the present invention that monitors for lost packets or for upstream lost packets.

FIG. 5 is a block diagram of a portion of the system according to the present invention that monitors the performance of the downstream QAM signal.

FIG. 6 is a block diagram of a cable modem status monitoring transponder or individual cable modem equipped with the present invention.

### DETAILED DESCRIPTION

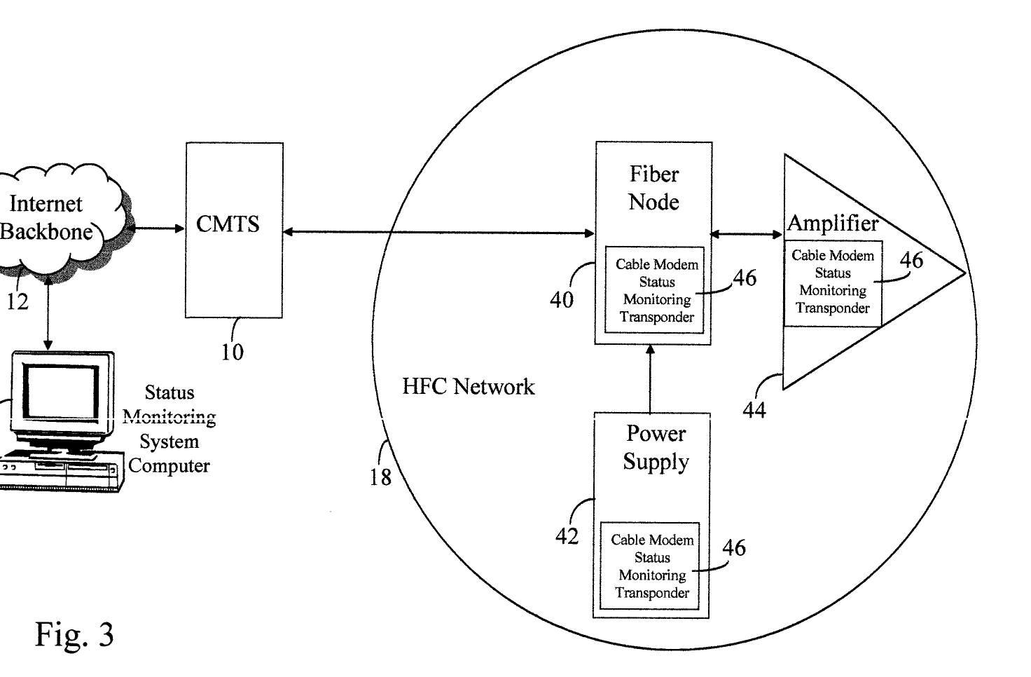

Referring to FIG. 3 a cable modem status monitoring transponder 46 according to the present invention is located somewhere in the HFC Network 18. Possible locations are in or near Fiber node 40, Power Supply 42 or Amplifier 44. These HFC Network components are well known in the art. An alternate embodiment of this invention would be to use a stand alone cable modem rather then a status monitoring transponder. Both would provide the same functionality as it relates to this invention.

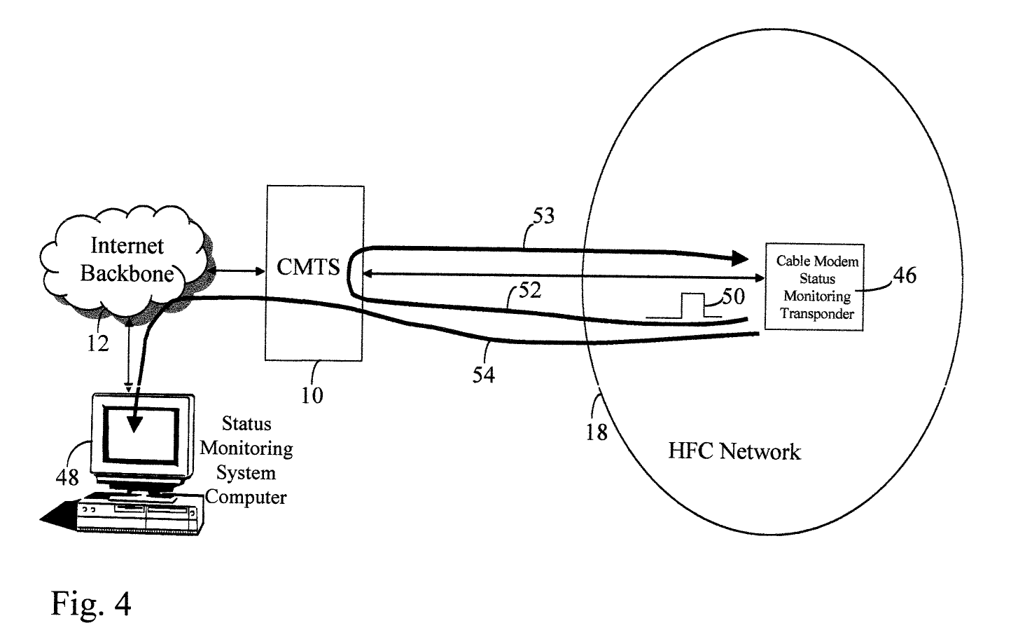

Referring to FIG. 4, the software inside the cable modem portion of cable modem transponder 46 is programmed to continuously generate a stream of test ping packets 50. These test ping packets are addressed to the CMTS 10 and sent on the upstream path 52 to CMTS 10. When the packet reaches CMTS 10 it is checked for any errors as per IP protocol using Cyclic Redundancy Check (CRC). This process of CRC checking of packets at a router is well known to the art. If the packet 50 is determined to be error free it is returned on the downstream path 53 and received by the cable modem status monitoring transponder 46. If the packet returns without errors the packet is assumed to be good and no lost packets are counted. In alternate embodiments packets can be sent to routers further in the network or somewhere in the Internet. This is a less desirable embodiment since pinging routers further into the network makes it impossible to be certain if the problem was a result of the HFC Network 18 or the local network or Internet Backbone 12.

A more desirable embodiment of the present invention is to further provide the ability to isolate lost packets to the upstream path only. A simple ping test with no further inspection will not isolate any lost packets to just the upstream as they could have been lost in the downstream path. Adding additional intelligence to the cable modem portion of cable modem status monitoring transponder 46 to isolate packets to the upstream is preferred. Methods for isolating lost packets to just the upstream path are described in application Ser. No. 09/704,888, System and Method for Testing the Upstream Channel of a Cable Network or application Ser. No. 10/083,749, System of testing the upstream cable modem channel.

Once it has been determined that one or more packets have been lost, and preferably lost only in the upstream path, cable modem status monitoring transponder 46 sends a signal 54 over the IP network to Status Monitoring System Computer 48, alerting the computer that packets are being lost. Depending on alarm thresholds pre-programmed by status monitoring system computer 48, cable system personnel may be alerted to the network problem. In alternate embodiments, cable modem status monitoring transponder 46 may contain software that determines the alarm threshold prior to alerting the status monitoring system computer 48.

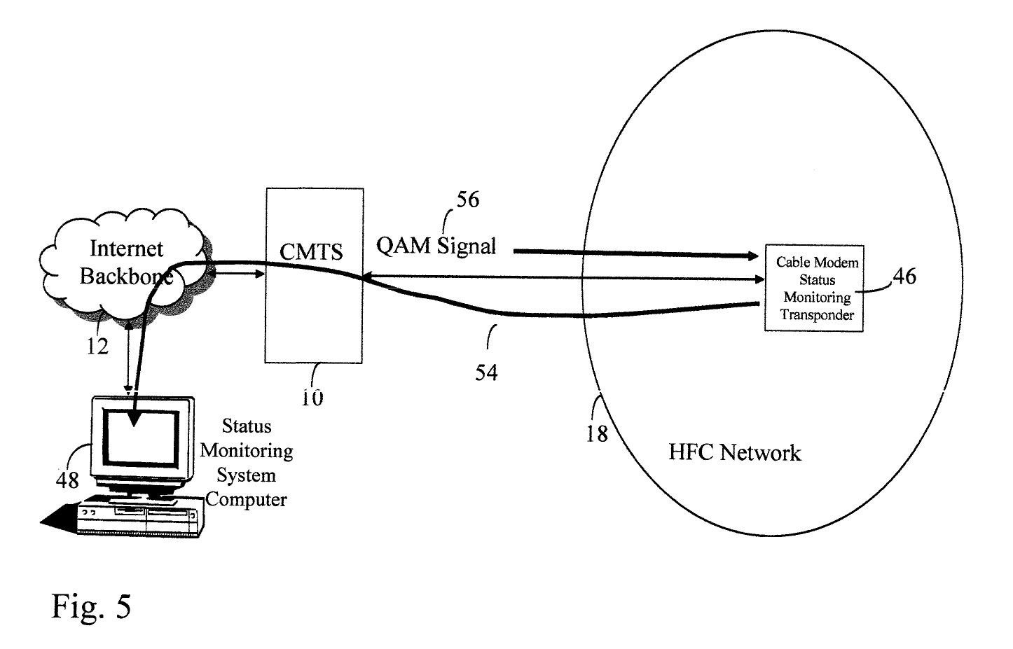

Referring to FIG. 5 a cable modem status monitoring transponder 46 is located somewhere in the HFC network 18. The cable modem status monitoring transponder 46 is programmed to analyze the received Cable Modem Quadrature Amplitude Modulation (QAM) Signal 56 that was transmitted from the CMTS 10 over the downstream path. This downstream QAM signal is well known to the art. It is also well known to the art that most cable modem hardware have the ability to analyze the QAM signal in terms of these parameters: MER, SNR, BER and receive level. Cable modem status monitoring transponder 46 is programmed to measure these parameters continuously and send the results of these measurements continuously to status monitoring system computer 48. In alternate embodiments, cable modem status monitoring transponder 46 may only transmit information on these measurements to status monitoring system computer 48 when any or all of the measurement parameters exceeds a pre-programmed limit or on a periodic basis when these measurement parameters do not exceed the pre-programmed limit.

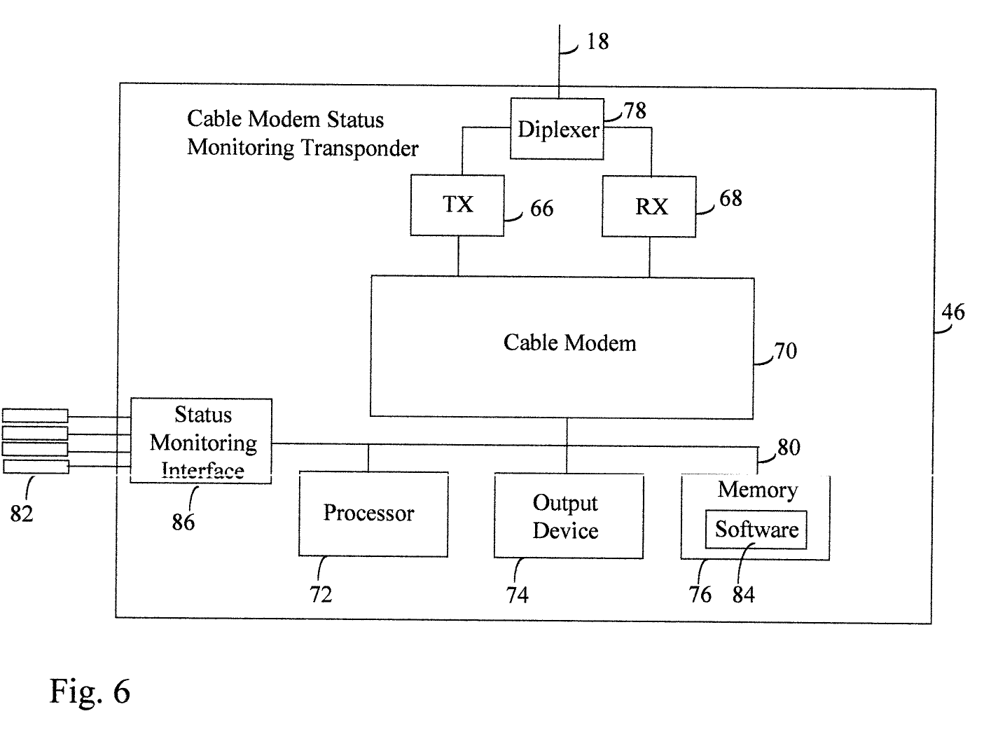

Referring to FIG. 6 a detailed view of the embodiment of cable modem status monitoring transponder 46 is shown. Cable modem status monitoring transponder comprises a cable modem 70, a processor 72, a memory 76, an output device 74, a bus 80, software program 84, status monitoring interface 86, a transmit port 66, a receive port 68, and a diplexer 78. Software program 84 contains the programs necessary to execute the tests described in this invention. Monitoring points 82 connect to status monitoring interface 86 which monitors the points that are normally monitored by a status monitoring transponder and is prior art. In a stand alone cable modem embodiment, status monitoring interface 86 is not used and no monitoring points 82 are monitored. While FIG. 6 is a typical embodiment of cable modem status monitoring transponder 46, those of ordinary skill in the art will recognize that cable modem status monitoring transponder 46 can be embodied in other components such as field programmable gate arrays, application specific integrated circuits and other components.

The preferred embodiment of the system of the present invention is as incorporated in a Cable Modem Application Specific Integrated Circuit (ASIC). Cable modem ASICs are available from Broadcom Corporation of Irvine, Calif. and other manufacturers. Some cable modem ASICs are provided with basic cable modem functionality along with means to program the ASIC with additional functionality.

1. A system for monitoring the performance of the cable modem upstream and downstream channels on a cable network, the system comprising:
A cable modem or cable modem status monitoring transponder;
A cable network equipped with a cable modem termination system (CMTS) that is connected to the Internet or private network; and
A central computer or computers for remotely monitoring performance;

2. The cable modem or cable modem status monitoring transponder in claim 1 equipped with software to continuously monitor and test the upstream and downstream channels for lost packets by using a string of ping packets destined for the CMTS or other router.

3. The cable modem or cable modem status monitoring transponder in claim 1 equipped with software to continuously monitor and test the upstream channel for lost packets by using a string of ping packets destined for the CMTS or other router, and means to isolate the lost packets to only the upstream path.

4. The cable modem or cable modem status monitoring transponder in claim 1 equipped with software to continuously monitor and test the downstream channel for Modulation Error Ratio (MER), Signal to Noise Ratio (SNR), Bit Error Rate (BER) and/or carrier level.

5. The cable modem or cable modem status monitoring transponder in claim 2, claim 3 or claim 4 equipped with software to transmit the results of upstream and/or downstream tests continuously to the central computer or computers in claim 1 over the cable network equipped with a cable modem termination system connected to the internet or private network in claim 1.

6. The cable modem or cable modem status monitoring transponder in claim 1 equipped with software to continuously compare the results of upstream and/or downstream tests in claim 2, claim 3 and claim 4 to predefined limits and transmit alarm conditions and/or measurement results when alarm conditions are exceeded to the computer or computers in claim 1 over the cable network equipped with a cable modem termination system connected to the internet or private network in claim 1.

7. The central computer or computers in claim 1 that contain software to receive the upstream and downstream measurement results from the cable modem or cable modem status monitoring transponder in claim 5.

8. The central computer or computers in claim 1 that contain software to receive the upstream and downstream alarm conditions and/or measurement results from the cable modem or cable modem status monitoring transponder in claim 6.
